(19) United States
(12) Patent Application Publication
(10) Pub. No.: US 2025/0384520 A1
(43) Pub. Date: Dec. 18, 2025

(54) VIDEO SUPER RESOLUTION SYSTEM AND METHOD FOR CALCULATING VIDEO SUPER RESOLUTION

(71) Applicant: REALTEK SEMICONDUCTOR CORPORATION, HSINCHU (TW)

(72) Inventor: KANG-YU LIU, HSINCHU (TW)

(21) Appl. No.: 19/202,599

(22) Filed: May 8, 2025

(30) Foreign Application Priority Data
Jun. 13, 2024 (TW) 113121933

(51) Int. Cl. G06T 3/4046; G06T 3/18; G06T 3/4053; G06T 7/269

(52) U.S. Cl. CPC G06T 3/4046; G06T 3/18; G06T 3/4053; G06T 7/269; G06T 2207/10016; G06T 2207/20081; G06T 2207/20084

(57) ABSTRACT

A video super resolution system includes a motion estimation device, a warping device, and a neural network super resolution (NNSR) device. The motion estimation device calculates an optical flow according to a current frame and a previous frame. The warping device executes a warping process to the previous frame and a previous output to generate a warping frame and a warping output. The NNSR device executes a feature extraction to the current frame, the warping frame, the warping output, and a count value to generate at least one feature, executes a deep learning process to the at least one feature and a previous hidden state to generate a current hidden state and a deep learning result, and executes the feature extraction to the deep learning result to generate a current output. The NNSR device stores the current frame, the current hidden state, and the current output to a memory.

### BACKGROUND OF THE INVENTION

### 1. Field of the Invention

The present disclosure relates to a video super resolution system and a video super resolution calculation method, especially to a video super resolution system and a video super resolution calculation method that only require information of a previous frame and adopt a recursive approach to process extremely long video streams.

### 2. Description of Related Art

Consumer demand for video quality is increasing, video super resolution (VSR) occurs accordingly. Video super resolution can significantly enhance video clarity. However, video super resolution has limitations and cannot be applied to real-time video. Applying video super resolution to real-time video requires substantial resources and consumes excessive power. Therefore, current hardware cannot achieve real-time video processing with video super resolution.

In addition, current video super resolution requires information of several future frames and past frames to execute calculations, leading to delays in real-time video (such as video in real-time online games). Furthermore, current video super resolution cannot handle extremely long video streams. Besides, current video super resolution performs poorly in dealing with noise and compression.

### SUMMARY OF THE INVENTION

In some aspects, an object of the present disclosure is to, but not limited to, provides a video super resolution system and a video super resolution calculation method that makes an improvement to the prior art.

An embodiment of a video super resolution system of the present disclosure includes a motion estimation device, a warping device, and a neural network super resolution device. The motion estimation device is configured to calculate an optical flow according to a current frame and a previous frame received from a memory. The warping device is configured to execute a warping process to the previous frame and a previous output received from the memory according to the optical flow to respectively generate a warping frame and a warping output. The neural network super resolution device is configured to execute a feature extraction to the current frame, the warping frame, the warping output, and a count value to generate at least one feature, execute a deep learning to the at least one feature and a previous hidden state of the previous output to generate a current hidden state and a deep learning result, and execute the feature extraction to the deep learning result to generate a current output. The neural network super resolution device stores the current frame, the current hidden state, and the current output to the memory.

An embodiment of a video super resolution calculation method of the present disclosure which is executed by a processor reading at least one command includes following steps: calculating an optical flow according to a current frame and a previous frame received from a memory; executing a warping process to the previous frame and a previous output received from the memory according to the optical flow to respectively generate a warping frame and a warping output; executing a feature extraction to the current frame, the warping frame, the warping output, and a count value to generate at least one feature; executing a deep learning to the at least one feature and a previous hidden state of the previous output to generate a current hidden state and a deep learning result; executing the feature extraction to the deep learning result to generate a current output; and storing the current frame, the current hidden state, and the current output to the memory.

Technical features of some embodiments of the present disclosure make an improvement to the prior art. The video super resolution system and the video super resolution calculation method of the present disclosure adopt a lightweight architecture and quantize relevant information, resulting in low power consumption. Therefore, the video super resolution system and the video super resolution calculation method can be applied in real-time video (such as video with 4K resolution and at a refresh rate of 120 Hz). The present disclosure only requires information of the previous frame to predict the current frame. Since the present disclosure does not require information from future frames, there is no video delay. Besides, the present disclosure utilizes a recursive approach to predict and process video, allowing the present disclosure to handle extremely long video streams. Moreover, the present disclosure can process video streams with noise and poor compression.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a video super resolution system and a memory of the present disclosure.

FIG. 2 shows an embodiment of a flow diagram of a video super resolution calculation method of the present disclosure.

FIG. 3 shows an embodiment of a motion estimation device of the present disclosure.

FIG. 4 shows an embodiment of a warping device of the present disclosure.

FIG. 5 shows an embodiment of a neural network super resolution device of the present disclosure.

FIG. 6 shows an embodiment of a video super resolution system and a memory of the present disclosure.

### DETAILED DESCRIPTION OF THE PREFERRED EMBODIMENTS

For solving the problem of video super resolution being unable to apply in real-time video, the problem of video delay caused by video super resolution, and the inability of video super resolution to handle extremely long video streams, the present disclosure provides a video super resolution system and a video super resolution calculation method, which will be explained in detail as provided below.

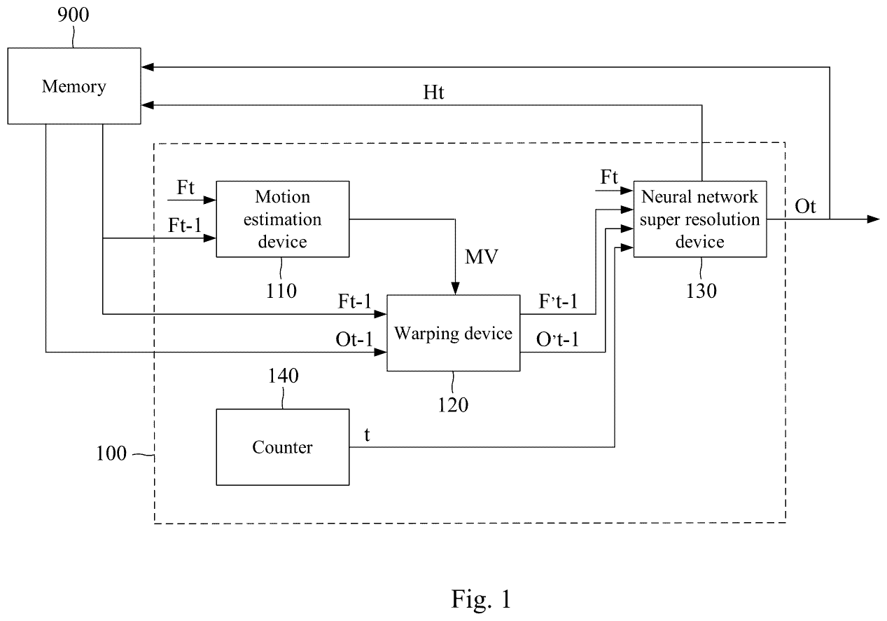

FIG. 1 shows an embodiment of a video super resolution system 100 and a memory 900 of the present disclosure. As shown in the figure, the video super resolution system 100 includes a motion estimation device 110, a warping device 120, a neural network super resolution device 130, and a counter 140. In some embodiments, the memory 900 can be a double data rate synchronous dynamic random access memory (DDR SDRAM).

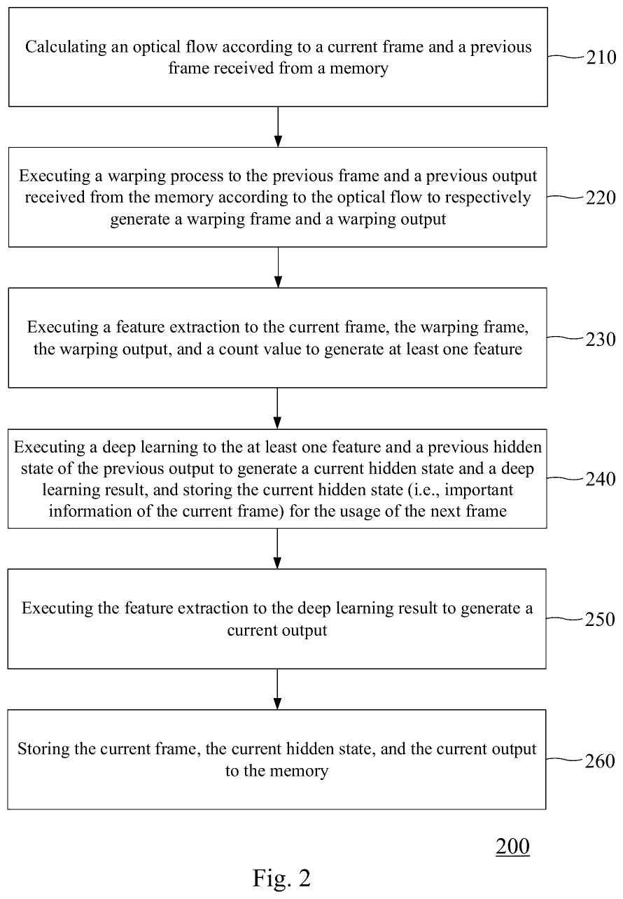

For facilitating the understanding of operations of the video super resolution system 100, please refer to FIG. 2, FIG. 2 shows an embodiment of a flow diagram of a video super resolution calculation method 200 of the present disclosure.

Referring to FIG. 1 and FIG. 2, in step 210, calculating an optical flow according to a current frame and a previous frame received from a memory. For example, the motion estimation device 110 can calculate the optical flow MV according to the current frame Ft and the previous frame Ft−1 received from the memory 900. The present disclosure only requires information of the previous frame to predict the current frame. Since the present disclosure does not require information from future frames, there is no video delay.

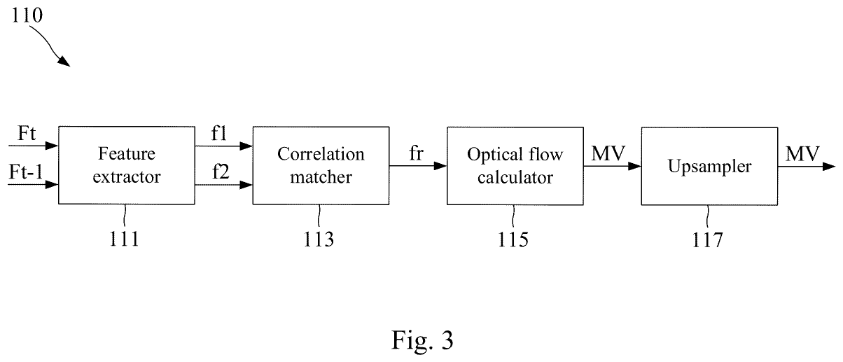

To further explain step 210, please refer to FIG. 3, FIG. 3 shows an embodiment of the motion estimation device 110 of the present disclosure. As shown in the figure, the motion estimation device 110 includes a feature extractor 111, a correlation matcher 113, an optical flow calculator 115, and an upsampler 117.

In some embodiments, the feature extractor 111 is configured to execute a feature extraction and a scaling down to the current frame and the previous frame to generate a plurality of high-level features. For example, the feature extractor 111 executes the feature extraction and the scaling down to the current frame Ft and the previous frame Ft−1 to generate high-level features (e.g., high-level features f1 and f2). The high-level feature can be a building feature, an environmental feature, or a face feature, which can be utilized to track an optical flow generated by a target moving among different frames. In addition, the correlation matcher 113 is configured to execute a correlation matching to a plurality of high-level features to generate a plurality of correlation features fr. For example, the correlation matcher 113 will execute the correlation matching to the high-level features (e.g., high-level features f1 and f2). The high-level feature with the highest possibility can be the same point among different frames (e.g., the current frame Ft and the previous frame Ft−1).

In some embodiments, the optical flow calculator 115 is configured to execute a calculation to the plurality of correlation features fr to generate the optical flow MV. For example, the correlation matcher 113 can calculate the same point among different frames (e.g., the current frame Ft and the previous frame Ft−1). The optical flow calculator 115 can calculate a corresponding optical flow MV according to the foregoing information. The optical flow MV can includes an optical flow (x flow) in X direction and an optical flow (y flow) in Y direction.

In some embodiments, the upsampler 117 is configured to execute an upsampling to the optical flow MV to generate the optical flow MV with an image size that is the same as the current frame Ft. For example, since the feature extractor 111 executes a scaling down to the current frame Ft and the previous frame Ft−1, the upsampler 117 therefore needs to execute the upsampling to the optical flow MV to generate the optical flow MV with the image size that is the same as the current frame Ft. In some embodiments, the upsampler 117 further executes a refinement to the optical flow MV. In some embodiments, the upsampler 117 can be an up-sample module. In some embodiments, the upsampler 117 can include a convolution layer and a scale-up module.

In step 220, executing a warping process to the previous frame and a previous output received from the memory according to the optical flow to respectively generate a warping frame and a warping output. For example, the warping device 120 can executing a warping process to the previous frame Ft−1 and a previous output Ot−1 received from the memory 900 according to the optical flow MV to respectively generate the warping frame F′t−1 and the warping output O′t−1.

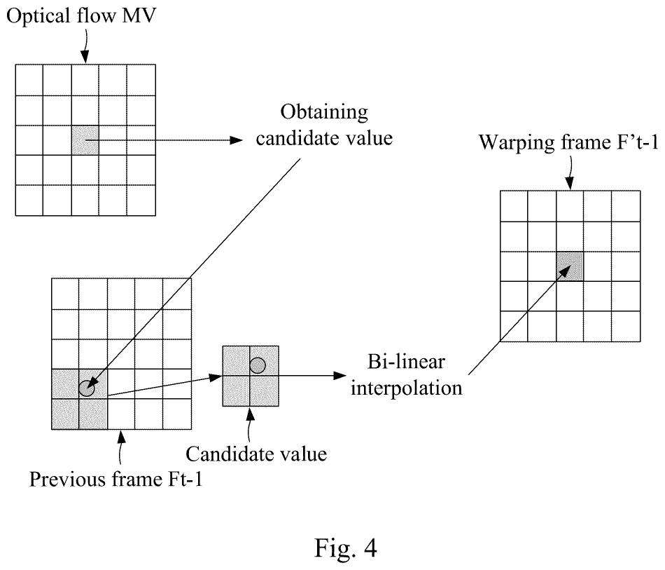

To further explain step 220, please refer to FIG. 4, FIG. 4 shows an embodiment of operations of a warping device 120 of the present disclosure. As shown in the figure, the warping device 120 obtains a plurality of candidate values from the previous frame Ft−1 according to the optical flow MV, and executes an interpolation the plurality of candidate values to generate a warping frame F′t−1. For example, the warping device 120 can select 4 candidate values from the previous frame Ft−1 according to a location information provided by the optical flow MV, and generate the warping frame F′t−1 through a bi-linear interpolation calculation.

In some embodiments, the warping device 120 obtains the plurality of candidate values from the previous output Ot−1 according to the optical flow MV, and executes the interpolation to the plurality of candidate values to generate the warping output O′t−1. For example, the warping device 120 can select 4 candidate values from the previous output Ot−1 according to the location information provided by the optical flow MV, and generate the warping output O′t−1 through the bi-linear interpolation calculation.

In step 230, executing a feature extraction to the current frame, the warping frame, the warping output, and a count value to generate at least one feature. For example, the neural network super resolution device 130 can execute the feature extraction to the current frame Ft, the warping frame F′t−1, the warping output O′t−1, and the count value t to generate at least one feature.

In some embodiments, the counter 140 can generate the count value t, and provide the count value t to the neural network super resolution device 130. The neural network super resolution device 130 can determine the processing stage through the count value t and execute adaptive processing methods at different stages. For example, early-stage processing may require noise reduction. However, in later stages, since the noise is smaller, noise reduction may not be necessary. Therefore, noise reduction will not be applied in the later stages. In view of the above, the neural network super resolution device 130 can handle video streams with noise and poor compression quality by executing adaptive processing methods based on the count value t.

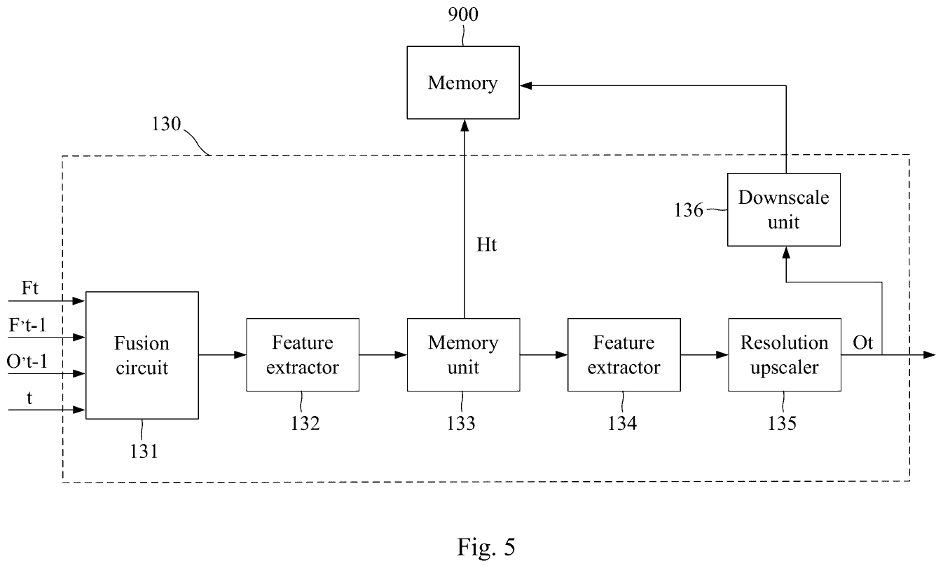

To further explain step 230, please refer to FIG. 5, FIG. 5 shows an embodiment of a neural network super resolution device 130 of the present disclosure. As shown in the figure, the neural network super resolution device 130 includes a fusion circuit 131, a feature extractor 132, a memory unit 133, a feature extractor 134, a resolution upscaler 135, and a downscale unit 136.

In some embodiments, the fusion circuit 131 is configured to execute a fusion calculation to the current frame Ft, the warping frame F′t−1, the warping output O′t−1, and the count value t in order to combine various information to generate a fusion result. The feature extractor 132 is configured to execute a feature extraction to the fusion result to generate at least one feature. In some embodiments, the fusion circuit 131 can be a fusion unit. In some embodiments, the fusion circuit 131 can include a convolution layer, a con-cat module, and a fully connected layer. In some embodiments, the feature extractor 132 can be a residual block.

In step 240, executing a deep learning to the at least one feature and a previous hidden state of the previous output to generate a current hidden state and a deep learning result, and storing the current hidden state (i.e., important information of the current frame) for the usage of the next frame. For example, the neural network super resolution device 130 can execute the deep learning to at least one feature and the previous hidden state of the previous output Ot−1 to generate a current hidden state Ht and a deep learning result, and store the current hidden state (i.e., important information of the current frame) for the usage of the next frame.

In some embodiments, the memory unit 133 is configured to execute the deep learning to the at least one feature and the previous hidden state to generate the current hidden state Ht and the deep learning result, and store the current hidden state Ht to the memory 900 for the usage of the next frame. In some embodiments, the memory unit 133 can include Convolutional Long Short-Term Memory (Conv-LSTM) and Convolutional Gated Recurrent Unit (Conv-GRU).

In step 250, executing the feature extraction to the deep learning result to generate a current output. For example, the neural network super resolution device 130 can execute the feature extraction to the deep learning result to generate the current output Ot.

In some embodiments, the feature extractor 134 is configured to execute the feature extraction to the deep learning result to generate a plurality of deep learning features. The resolution upscaler 135 is configured to execute a resolution upscaling to the plurality of deep learning features to generate the current output Ot. In some embodiments, the feature extractor 134 can be a residual block. In some embodiments, the resolution upscaler 135 can be a resolution upscale unit. In some embodiments, the resolution upscaler 135 can include a pixel-shuffle module, or the resolution upscaler 135 can include a convolution layer and a scale-up module.

In step 260, storing the current frame, the current hidden state, and the current output to the memory. For example, the neural network super resolution device 130 can store the current frame Ft, the current hidden state Ht, and the current output Ot to the memory 900. The present disclosure can store the current frame Ft, the current hidden state Ht, and the current output Ot to the memory 900 for the usage of the next frame. In other words, the present disclosure adopts a recursive manner to predict and process video. Therefore, the present disclosure can handle extremely long video streams (for example, video streams with more than 1000 frames).

In some embodiments, the downscale unit 136 is configured to execute a pixel rearrangement to the current output Ot to generate the current output Ot with an aspect ratio that is the same as the current frame. The downscale unit 136 can execute a scaling down without losing resolution information. For example, the downscale unit 136 can be, but is not limited to a pixel unshuffle unit, which can be configured to downscale the current output Ot to an aspect ratio related to its original size and store the current output Ot to the memory 900 for the usage of the next frame, and the pixel unshuffle unit can execute the scaling down without losing resolution information.

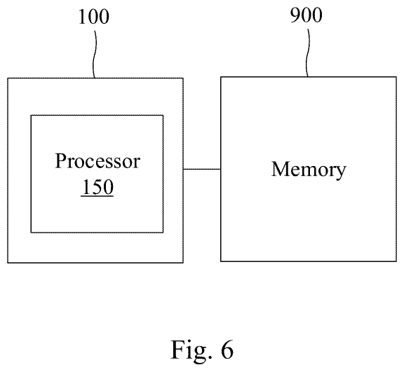

FIG. 6 shows an embodiment of a video super resolution system 100 and a memory 900 of the present disclosure. As shown in the figure, the present disclosure can utilize the processor 150 to execute at least command to implement the video super resolution calculation method 200 of FIG. 2. For example, the present disclosure can utilize the processor 150 to execute at least command in the memory 900 to perform related control operations, thereby controlling various devices/components of FIG. 1 to execute the video super resolution calculation method 200 of FIG. 2.

It is noted that the present disclosure is not limited to the embodiments as shown in FIG. 1 to FIG. 6, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The video super resolution system 100 and the video super resolution calculation method 200 of the present disclosure adopt a lightweight architecture and quantize relevant information, resulting in low power consumption. Therefore, the video super resolution system 100 and the video super resolution calculation method 200 can be applied in real-time video (such as video with 4K resolution and at a refresh rate of 120 Hz). The present disclosure only requires information of the previous frame to predict the current frame. Since the present disclosure does not require information from future frames, there is no video delay. Besides, the present disclosure utilizes a recursive approach to predict and process video, allowing the present disclosure to handle extremely long video streams. Moreover, the present disclosure can process video streams with noise and poor compression.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A video super resolution system, comprising:
a motion estimation device, configured to calculate an optical flow according to a current frame and a previous frame received from a memory;
a warping device, configured to execute a warping process to the previous frame and a previous output received from the memory according to the optical flow to respectively generate a warping frame and a warping output; and
a neural network super resolution device, configured to execute a feature extraction to the current frame, the warping frame, the warping output, and a count value to generate at least one feature, execute a deep learning to the at least one feature and a previous hidden state of the previous output to generate a current hidden state and a deep learning result, and execute the feature extraction to the deep learning result to generate a current output;
wherein the neural network super resolution device stores the current frame, the current hidden state, and the current output to the memory.

2. The video super resolution system of claim 1, wherein the motion estimation device comprises:
a feature extractor, configured to execute the feature extraction and a scaling down to the current frame and the previous frame to generate a plurality of high-level features; and
a correlation matcher, configured to execute a correlation matching to the plurality of high-level features to generate a plurality of correlation features.

3. The video super resolution system of claim 2, wherein the motion estimation device further comprises:
an optical flow calculator, configured to execute a calculation to the plurality of correlation features to generate the optical flow.

4. The video super resolution system of claim 3, wherein the motion estimation device further comprises:
an upsampler, configured to execute an upsampling to the optical flow to generate the optical flow with an image size that is the same as the current frame.

5. The video super resolution system of claim 1, wherein the warping device obtains a plurality of candidate values from the previous frame according to the optical flow, and executes an interpolation to the plurality of candidate values to generate the warping frame.

6. The video super resolution system of claim 1, wherein the warping device obtains a plurality of candidate values from the previous output according to the optical flow, and executes an interpolation to the plurality of candidate values to generate the warping output.

7. The video super resolution system of claim 1, wherein the neural network super resolution device comprises:
a fusion circuit, configured to execute a fusion calculation to the current frame, the warping frame, the warping output, and the count value to generate a fusion result; and
a feature extractor, configured to execute the feature extraction to the fusion result to generate the at least one feature.

8. The video super resolution system of claim 1, wherein the neural network super resolution device comprises:
a memory unit, configured to execute the deep learning to the at least one feature and the previous hidden state to generate the current hidden state and the deep learning result, and store the current hidden state to the memory.

9. The video super resolution system of claim 1, wherein the neural network super resolution device comprises:
a feature extractor, configured to execute the feature extraction to the deep learning result to generate a plurality of deep learning features; and
a resolution upscaler, configured to execute a resolution upscaling to the plurality of deep learning features to generate the current output.

10. The video super resolution system of claim 1, wherein the neural network super resolution device comprises:
a downscale unit, configured to execute a pixel rearrangement to the current output to generate the current output with an aspect ratio that is the same as the current frame.

11. A video super resolution calculation method, executed by a processor reading at least one command stored in a memory, comprising:
calculating an optical flow according to a current frame and a previous frame received from a memory;
executing a warping process to the previous frame and a previous output received from the memory according to the optical flow to respectively generate a warping frame and a warping output;
executing a feature extraction to the current frame, the warping frame, the warping output, and a count value to generate at least one feature;
executing a deep learning to the at least one feature and a previous hidden state of the previous output to generate a current hidden state and a deep learning result;
executing the feature extraction to the deep learning result to generate a current output; and
storing the current frame, the current hidden state, and the current output to the memory.

12. The video super resolution calculation method of claim 11, wherein calculating the optical flow according to the current frame and the previous frame received from the memory comprises:
executing the feature extraction and a scaling down to the current frame and the previous frame to generate a plurality of high-level features; and
executing a correlation matching to the plurality of high-level features to generate a plurality of correlation features.

13. The video super resolution calculation method of claim 12, wherein calculating the optical flow according to the current frame and the previous frame received from the memory comprises:
executing a calculation to the plurality of correlation features to generate the optical flow.

14. The video super resolution calculation method of claim 13, wherein calculating the optical flow according to the current frame and the previous frame received from the memory comprises:
executing an upsampling to the optical flow to generate the optical flow with an image size that is the same as the current frame.

15. The video super resolution calculation method of claim 11, wherein executing the warping process to the previous frame and the previous output received from the memory according to the optical flow to respectively generate the warping frame and the warping output comprises:
obtaining a plurality of candidate values from the previous frame according to the optical flow, and executing an interpolation to the plurality of candidate values to generate the warping frame.

16. The video super resolution calculation method of claim 11, wherein executing the warping process to the previous frame and the previous output received from the memory according to the optical flow to respectively generate the warping frame and the warping output comprises:
obtaining a plurality of candidate values from the previous output according to the optical flow, and executing an interpolation to the plurality of candidate values to generate the warping output.

17. The video super resolution calculation method of claim 11, wherein executing the feature extraction to the current frame, the warping frame, the warping output, and the count value to generate the at least one feature comprises:
executing a fusion calculation to the current frame, the warping frame, the warping output, and the count value to generate a fusion result; and
executing the feature extraction to the fusion result to generate the at least one feature.

18. The video super resolution calculation method of claim 11, wherein executing the deep learning to the at least one feature and the previous hidden state of the previous output to generate the current hidden state and the deep learning result comprises:
executing the deep learning to the at least one feature and the previous hidden state to generate the current hidden state and the deep learning result, and storing the current hidden state to the memory.

19. The video super resolution calculation method of claim 11, wherein executing the feature extraction to the deep learning result to generate the current output comprises:
executing the feature extraction to the deep learning result to generate a plurality of deep learning features; and
executing a resolution upscaling to the plurality of deep learning features to generate the current output.

20. The video super resolution calculation method of claim 11, further comprising:
executing a pixel rearrangement to the current output to generate the current output with an aspect ratio that is the same as the current frame.
